(19) United States
(12) Patent Application Publication
(10) Pub. No.: US 2011/0290121 A1
(43) Pub. Date: Dec. 1, 2011

(54) AUTOMATIC BREAD MAKING MACHINE

(76) Inventors: Teruaki TAGUCHI, Tottori City (JP); Toshiharu Fujiwara, Tottori City (JP); Yoshinari Shirai, Tottori City (JP); Masao Hayase, Tottori City (JP); Masayuki Shimozawa, Tottori City (JP)

(21) Appl. No.: 12/791,273

(22) Filed: Jun. 1, 2010

(51) Int. Cl. A21B 7/00

(52) U.S. Cl. 99/348

(57) ABSTRACT

An automatic bread making machine that sequentially performs a mixing/kneading process, a leavening process, and a baking process includes: a bread container that is used to contain a bread making ingredient and that has a passive spindle that permits selective attachment of a mixing/kneading blade or a grinding blade in a bottom part of the bread container; a baking chamber that is provided inside a cabinet of the automatic bread making machine and that houses the bread container; a first driving spindle that is disposed in a bottom part of the baking chamber and that is so disposed that it can be coupled to the passive spindle to feed it with rotation for the mixing/kneading blade; and a second driving spindle that is disposed in the bottom part of the baking chamber in a position deviated from the first driving spindle and that is so disposed that it can be coupled to the passive spindle to feed it with rotation for the grinding blade.

### BACKGROUND OF THE INVENTION

1. Field of the Invention

The present invention relates to an automatic bread making machine mainly for household use.

2. Description of Related Art

Commercially available automatic bread making machines for household use are generally configured to go through the following processes to make bread: a bread container (pan) filled with ingredients for making bread (bread making ingredients) is placed in a baking chamber inside the cabinet of the automatic bread making machine; then the bread making ingredients in the bread container is mixed and kneaded with a kneading blade to form dough; the dough is then left to leaven; the dough is then baked into bread, with the bread container itself serving as a baking pan. Patent Document 1 listed below discloses an example of an automatic bread making machine.

The bread making ingredients are often mixed with additional ingredients such as raisin and nuts to make mixed bread. Patent Document 2 listed below discloses an automatic bread making machine incorporating a means for automatically mixing additional (secondary) ingredients such as raisin, nuts, and cheese.

Patent Document 1: JP-A-2000-116526

Patent Document 2: JP-B-3191645

### SUMMARY OF THE INVENTION

Conventionally, the making of bread starts with the procurement of flour prepared from cereals such as wheat and rice, or instead mixed flour products containing flour mixed with various additional ingredients. Even when someone has a cereal grain (typically, rice) at hand, it is difficult to make bread directly from it. In view of the foregoing, it is an object of the present invention to provide an automatic bread making machine incorporating a mechanism convenient for making bread directly from cereal grain without going through a flour preparation process, and thereby to popularize bread making.

To achieve the above object, according to the invention, an automatic bread making machine that sequentially performs a mixing/kneading process, a leavening process, and a baking process is provided with: a bread container for containing a bread making ingredient, the bread container having a passive spindle that permits selective attachment of a mixing/kneading blade or a grinding blade in a bottom part of the bread container; a baking chamber provided inside a cabinet of the automatic bread making machine, for housing the bread container; a first driving spindle disposed in a bottom part of the baking chamber, the first driving spindle being so disposed that the first driving spindle can be coupled to the passive spindle to feed the passive spindle with rotation for the mixing/kneading blade; and a second driving spindle disposed in the bottom part of the baking chamber in a position deviated from the first driving spindle, the second driving spindle being so disposed that the second driving spindle can be coupled to the passive spindle to feed the passive spindle with rotation for the grinding blade.

With this construction, first, the bread container is placed in the baking chamber in such a way that the passive spindle having the grinding blade attached to it is coupled to the second driving spindle; cereal grain is then put in the bread container, and is then ground with the grinding blade. In this way, bread making ingredients are prepared inside the bread container. Thereafter, the grinding blade is replaced with the mixing/kneading blade, and the bread container is relocated so that the passive spindle is coupled to the first driving spindle; the bread making ingredients are then mixed and kneaded, and then go through further processes, specifically leavening and baking. Thus, the cereal grain that has been ground inside the bread container can be, while left there, baked into bread inside the bread container. This, compared with grinding the cereal grain in another container and then moving it over into the bread container, helps eliminate loss of the ingredients inevitable when they are moved over, as results from part of them being left behind in the other container.

According to the invention, in the automatic bread making machine described above, the first and second driving spindles may be driven by a common motor.

With this construction, it is possible to accomplish the operation of the automatic bread making machine with a minimal number of motors, e.g., a single motor, and thereby to reduce component costs.

According to the invention, in the automatic bread making machine described above, the first and second driving spindles may be driven by separate motors.

With this construction, it is easy to give each of the mixing/kneading blade and the grinding blade an optimal rotation rate.

According to the invention, in the automatic bread making machine described above, the motor for rotating the first driving spindle and the motor for rotating the second driving spindle may be controlled by a common control device.

With this construction, it is possible to control the rotation of the grinding blade and the rotation of the mixing/kneading blade in association with each other. Thus, at each of the stage of grinding cereal grain and the stage of mixing/kneading the cereal grain after the grinding, it is possible to feed the grinding blade and the mixing/kneading blade with rotation suitable for the kind and amount of cereal grain, and thereby to enhance the quality of the bread.

With an automatic bread making machine according to the invention, it is possible to make bread from cereal grain without going through a flour preparation process. It is thus possible to popularize bread making.

### BRIEF DESCRIPTION OF THE DRAWINGS

FIG. 1 is a vertical sectional view of an automatic bread making machine according to Embodiment 1 of the invention;

FIG. 2 is a top view of the automatic bread making machine shown in FIG. 1, in its state with a lid removed;

FIG. 3 is a top view of the automatic bread making machine, in its state with a bread container further removed from the state shown in FIG. 2;

FIG. 4 is a vertical sectional view of the automatic bread making machine according to Embodiment 1 of the invention, showing a state different from that shown in FIG. 1;

FIG. 5 is a top view of the automatic bread making machine shown in FIG. 4, in its state with a lid removed;

FIG. 6 is a control block diagram of the automatic bread making machine according to Embodiment 1 of the invention;

FIG. 7 is an overall flow chart of a bread making procedure of Example 1 of the invention;

FIG. 8 is a flow chart of a pre-grinding soaking process in the bread making procedure of Example 1;

FIG. 9 is a flow chart of a grinding process in the bread making procedure of Example 1;

FIG. 10 is a flow chart of a mixing/kneading process in the bread making procedure of Example 1;

FIG. 11 is a flow chart of a leavening process in the bread making procedure of Example 1;

FIG. 12 is a flow chart of a baking process in the bread making procedure of Example 1;

FIG. 13 is an overall flow chart of a bread making procedure of Example 2 of the invention;

FIG. 14 is a flow chart of a pre-grinding soaking process in the bread making procedure of Example 2;

FIG. 15 is an overall flow chart of a bread making procedure of Example 3 of the invention;

FIG. 16 is a vertical sectional view of an automatic bread making machine according to Embodiment 2 of the invention;

FIG. 17 is a vertical sectional view of the automatic bread making machine according to Embodiment 2 of the invention, taken in a direction perpendicular to FIG. 16;

FIG. 18 is a vertical sectional view of the automatic bread making machine according to Embodiment 2 of the invention, showing a state different from that shown in FIG. 16; and

FIG. 19 is a control block diagram of the automatic bread making machine according to Embodiment 2 of the invention.

### DETAILED DESCRIPTION OF PREFERRED EMBODIMENTS

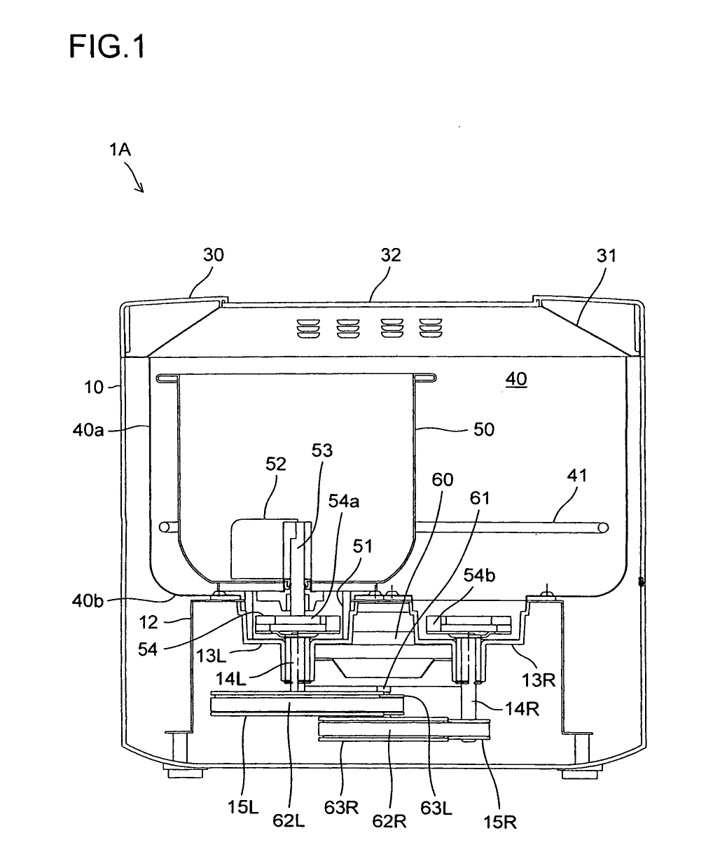

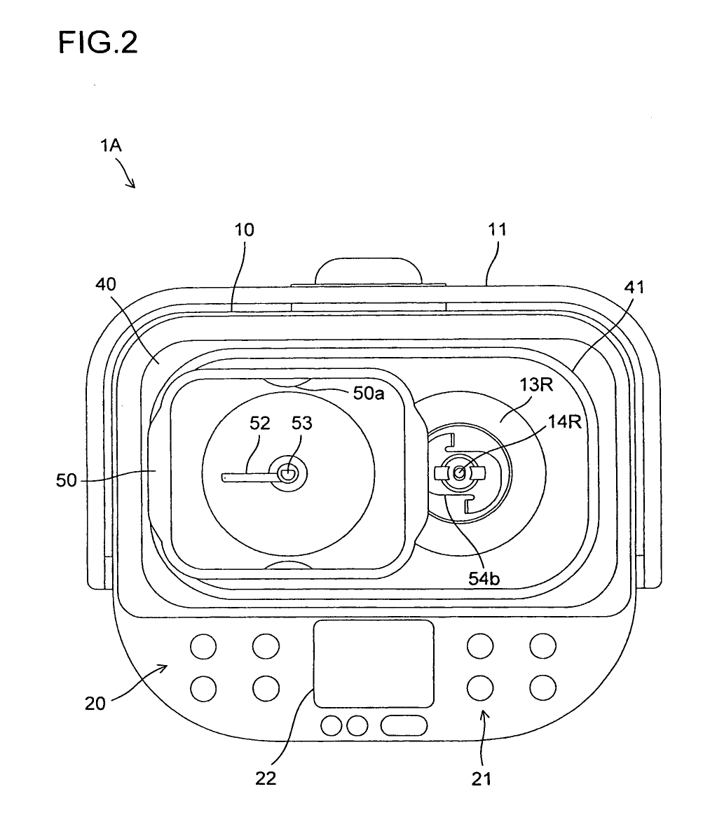

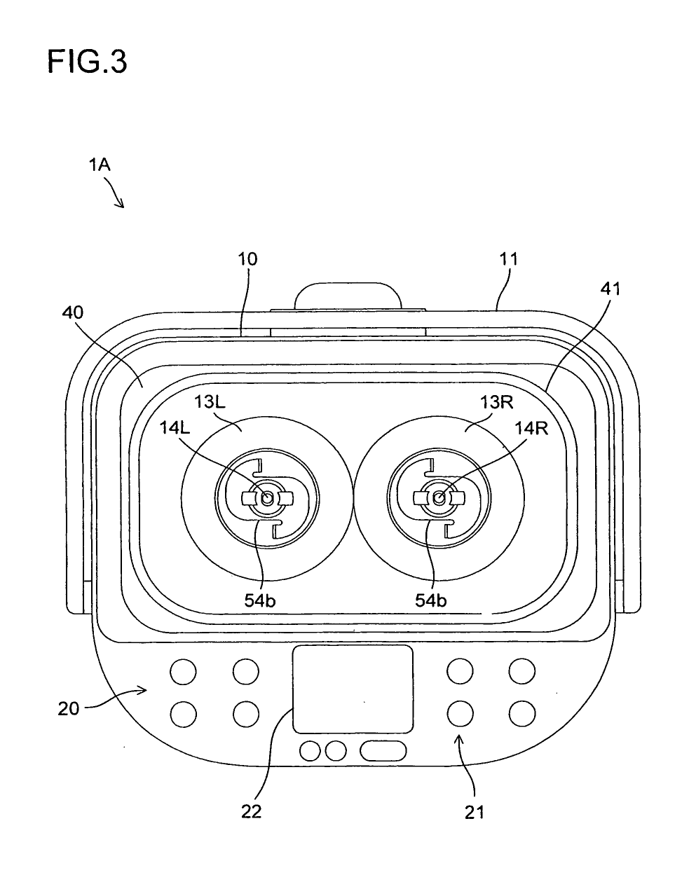

A first embodiment (Embodiment 1) of the invention will be described below with reference to FIGS. 1 to 15. In FIGS. 1 to 5, the left side of the drawing corresponds to the left side of an automatic bread making machine 1A, and the right side of the drawing corresponds to the right side of the automatic bread making machine 1A. In FIGS. 2, 3, and 5, the bottom side of the drawing corresponds to the front (facade) side of the automatic bread making machine 1A, and the top side of the drawing corresponds to the rear (back) side of the automatic bread making machine 1A.

The automatic bread making machine 1 A has a box-shaped cabinet 10. The cabinet 10 has an outer casing formed of synthetic resin, and is portable with a C-shaped handle 11 (see FIG. 2) formed of synthetic resin of which both ends are coupled to the left and right side faces, respectively, of the outer casing.

In a front part of the top face of the cabinet 10, an operation portion 20 is formed. The operation portion 20 is provided with operation keys 21 including a bread type selection key (for selection among wheat bread, rice bread, mixed bread, etc.), a recipe selection key, a timer key, a start key, a cancel key, etc., and a display portion 22 for displaying the specified recipe, the timer-set hour, etc. The display portion 22 comprises a liquid crystal display panel.

The part of the cabinet top face behind the operation portion 20 is covered by a lid 30 formed of synthetic resin. The lid 30 is attached to a rear-side edge of the cabinet 10 with an unillustrated hinge shaft, and swings about the hinge shaft in a vertical plane.

Inside the cabinet 10, a baking chamber 40 is provided. The baking chamber 40 is formed out of sheet metal, and is open at the top face, through which opening a bread container 50 is put in the baking chamber 40. The baking chamber 40 has a circumferential wall 40a with a rectangular horizontal cross-section, and a bottom wall 40b. The baking chamber 40 is supported by the bottom wall 40b being placed on a base 12 formed out of sheet metal provided inside the cabinet 10.

On the base 12, bread container supporting portions 13L and 13R formed as die castings of an aluminum alloy are fixed at deviated positions, specifically at the left and right of the center of the baking chamber 40, at a predetermined interval from each other. The insides of the bread container supporting portions 13L and 13R communicate with the inside of the baking chamber 40 via openings formed in the base 12 and an opening formed in the bottom wall 40b of the baking chamber 40.

At the center of the bread container support portion 13L, a first driving spindle 14L is vertically supported. The bottom end of the first driving spindle 14L protrudes from the bottom face of the bread container support portion 13L, and a pulley 15L is fixed there.

At the center of the bread container support portion 13R, a second driving spindle 14R is vertically supported. The bottom end of the second driving spindle 14R protrudes from the bottom face of the bread container support portion 13R, and a pulley 15R is fixed there.

The bread container supporting portions 13L and 13R support the bread container 50 by receiving a cylindrical pedestal 51 fixed to the bottom face of the bread container 50. The pedestal 51, too, is formed as a die casting of an aluminum alloy.

The bread container 50 is formed of sheet metal, is shaped like a bucket, and is, in a rim part, fitted with a handle (unillustrated) for hand carrying. The bread container 50 has a rectangular horizontal cross section with rounded corners, and on the inner surface along two opposite sides, of the four in total, of the rectangular shape, vertically extending ridge-shaped protrusions 50a (see FIG. 2) are formed.

At the center of a bottom part of the bread container 50, a mixing(blending)/kneading blade 52 is disposed. The mixing/kneading blade 52 is attached to, by simply being fitted into, a top-end part, with a non-circular cross section, of a passive spindle 53 which is vertically supported at the center of the bottom part of the bread container 50 with appropriate sealing applied. The mixing/kneading blade 52 can thus be attached and detached without any tool. This allows easy interchanging of different types of mixing/kneading blades 52.

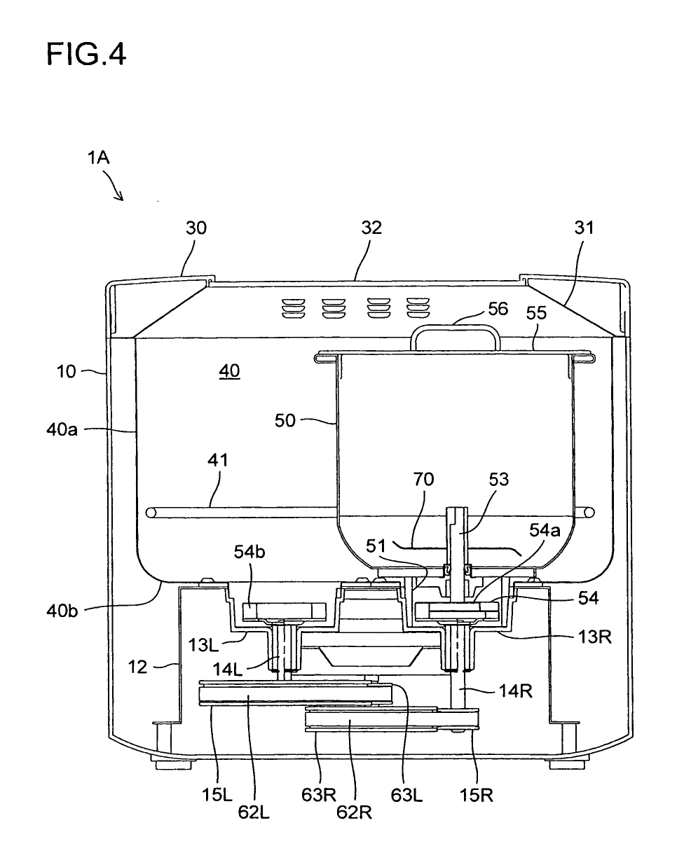

Instead of the mixing/kneading blade 52, a grinding (milling) blade 70 (see FIG. 4) can be attached to the passive spindle 53. The grinding blade 70, too, is attached to, by simply being fitted into, the top-end, non-circular-cross-sectioned part of the passive spindle 53.

The passive spindle 53 is coupled either to the first driving spindle 14L or to the second driving spindle 14R to receive a driving force. The transmission of the driving force here is achieved by a coupling 54 enclosed in the pedestal 51. Specifically, the coupling 54 is composed of two members, one member 54a being fixed to the bottom end of the passive spindle 53, and the other member 54b being one of a member fixed to the top end of the first driving spindle 14L and a member fixed to the top end of the second driving spindle 14R

On the outer circumferential surface of the pedestal 51, an unillustrated projection is formed, and correspondingly, an unillustrated cut through which the projection passes is formed in the rim of each of the openings formed in the base 12 to correspond to the bread container supporting portions 13L and 13R respectively. Together the projection and the cut form a well-known bayonet construction. Specifically, when the bread container 50 is attached to the bread container support portion 13L or 13R, first the bread container 50 is lowered with the projection and the cut at the same angle; after the projection has passed through the cut, the bread container 50 is turned horizontally; this causes the projection to engage with the inner rim of the opening in the base 12, thereby preventing the bread container 50 from coming off upward. The operation simultaneously couples the coupling 54. The direction in which the bread container 50 is turned when attached is made the same as the rotation direction of the mixing/kneading blade 52 or the grinding blade 70. This prevents the bread container 50 from coming loose as the mixing/kneading blade 52 or the grinding blade 70 rotates.

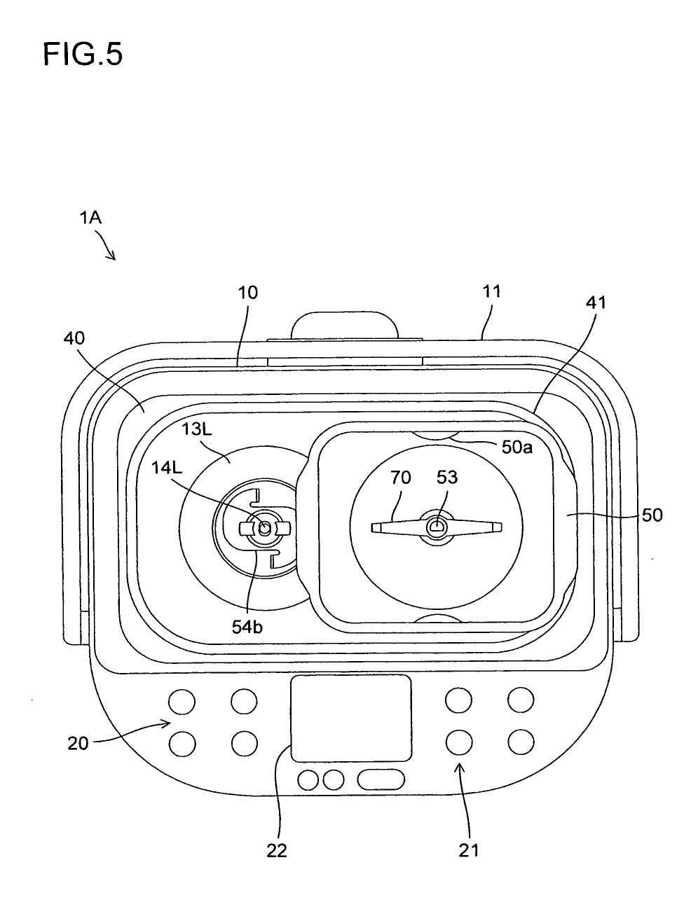

When the bread container 50 is attached to the bread container support portion 13L, with the passive spindle 53 coupled to the first driving spindle 14L, the bread container 50 is located at the left inside the baking chamber 40 as shown in FIGS. 1 and 2. When the bread container 50 is attached to the bread container support portion 13R, with the passive spindle 53 coupled to the second driving spindle 14R, the bread container 50 is located at the right inside the baking chamber 40 as shown in FIGS. 4 and 5. Thus, so that the bread container 50 may be housed in different position inside the baking chamber 40, the baking chamber 40 has a shape elongate in the left/right direction.

A heating device 41 disposed inside the baking chamber 40 surrounds the bread container 50 to heat bread making ingredients. The heating device 41 comprises a sheathed heater.

The base 12 is fitted with a motor 60. The motor 60 is of a vertical spindle type, and its output spindle 61 protrudes from its bottom face. To the output spindle 61 are fixed a pulley 63L which is coupled via a belt 62L to the pulley 15L on the first driving spindle 14L and a pulley 63R which is coupled via a belt 62R to the pulley 15R on the second driving spindle 14R.

The first driving spindle 14L is for rotating the mixing/kneading blade 52, and is therefore required to rotate at low speed and high torque. The second driving spindle 14R is for rotating the grinding blade 70, and is therefore required to rotate at high speed. Accordingly, the diameter ratios among the pulleys are so set that the pulley 63L makes the pulley 15L rotate at reduced speed and that the pulley 63R makes the pulley 15R at increased speed. Producing two types of rotation with different properties from a single motor 60 in this way helps reduce component cost.

The lid 30 is, at its part covering the baking chamber 40, provided with a ceiling 31. The ceiling 31 is formed of sheet metal molded into a dome shape, and a peak part of the ceiling 31 connects to a sight window 32 provided in the lid 30. The sight window 32 has heat-resistant glass set in it.

For the bread container 50, an inner lid 55 (see FIG. 4) is provided. The inner lid 55 is formed of metal, is shaped like a common pot lid, and is provided with a knob 56 at the center of the top face.

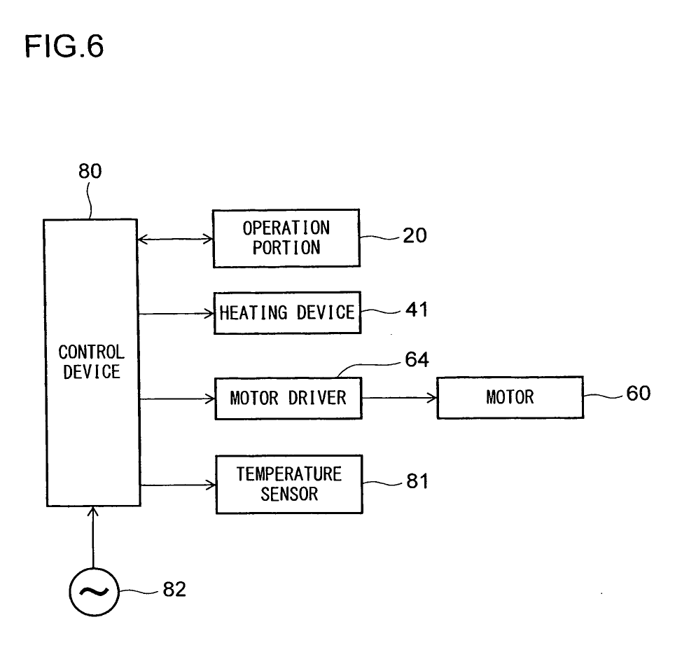

The operation of the automatic bread making machine 1A is controlled by a control device 80 shown in FIG. 6. The control device 80 comprises a circuit board disposed in an appropriate place (preferably where heat from the baking chamber 40 has little effect) inside the cabinet 10, and to it are connected, in addition to the operation portion 20 and the heating device 41 already mentioned, a motor driver 64 for the motor 60 and a temperature sensor 81. The temperature sensor 81 is disposed inside the baking chamber 40, and monitors the temperature in the baking chamber 40. The individual constituent blocks are supplied with electric power from a commercial electric power source 82.

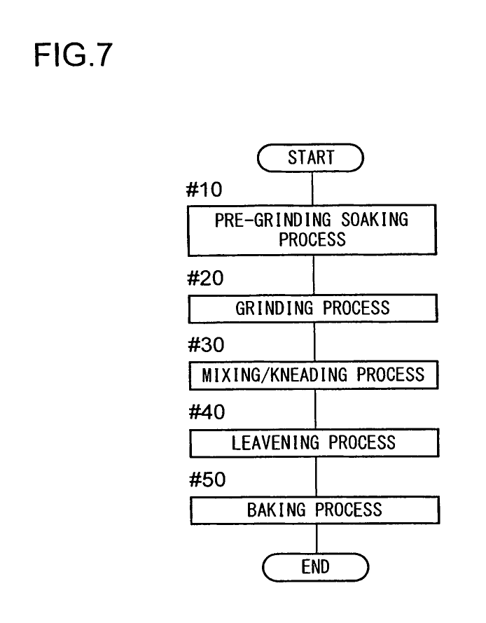

Next, a procedure for making bread from cereal grain by use of the automatic bread making machine 1A will be described with reference to FIGS. 7 to 15. Of these charts, FIGS. 7 to 12 show a first example (Example 1) of a bread making procedure.

FIG. 7 is an overall flow chart of the bread making procedure of Example 1. In FIG. 7, different processes are gone through in the following order: a pre-grinding soaking process #10, a grinding (milling) process #20, a mixing (blending)/kneading process #30, a leavening (fermenting) process #40, and a baking process #50. What takes place in each of these process will now be described.

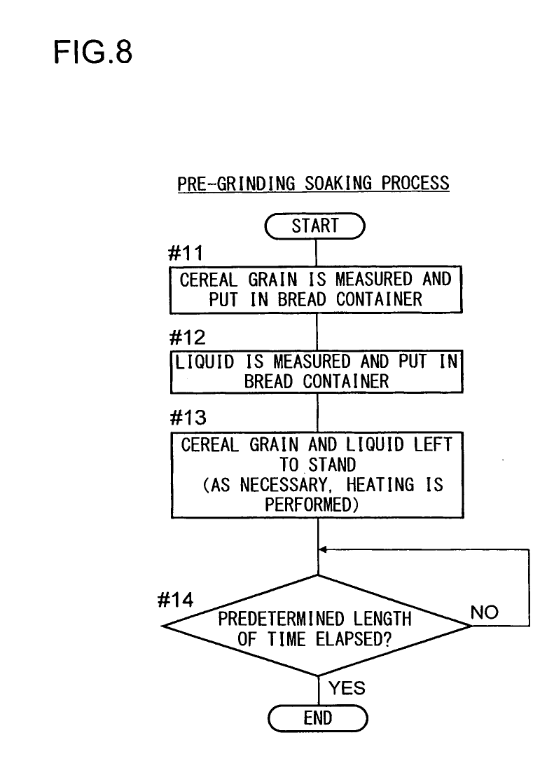

In the pre-grinding soaking process #10 shown in FIG. 8, first, at step #11, the user measures cereal grain, and puts a predetermined amount of it in the bread container 50. Among various kinds of cereal grain, rice grain is most easily available; it is however also possible to use grain of any other kind of cereal, for example wheat, barley, millet, Japanese millet, buckwheat, maize, etc.

At step #12, the user measures liquid, and puts a predetermined amount of it in the bread container 50. The commonest liquid here is water; it is however also possible to use a seasoned or otherwise prepared liquid such as a soup stock, or a fruit juice; it may even contain alcohol. Steps #11 and #12 may be reversed in order.

The operation of putting cereal grain and liquid in the bread container 50 may be done with the bread container 50 taken out of the baking chamber 40, or with the bread container 50 kept in the baking chamber 40. In a case where the operation is done with the bread container 50 kept inside the baking chamber 40, as shown in FIGS. 4 and 5, the bread container 50 is attached to the bread container support portion 13R and the passive spindle 53 is coupled to the second driving spindle 14R. The grinding blade 70 is attached to the passive spindle 53. Also in a case where cereal grain and liquid are put in the bread container 50 outside the baking chamber 40, the grinding blade 70 is attached to the passive spindle 53.

After cereal grain and liquid have been put in the bread container 50 inside the baking chamber 40, or after the bread container 50 having cereal grain and liquid put in it outside has been attached to the bread container support portion 13R, as shown in FIG. 4, the inner lid 55 is placed over the bread container 50, and the lid 30 is closed. Now, the user presses a predetermined operation key in the operation portion 20 to start the counting of the duration of soaking in liquid. This starts step #13.

At step #13, the grain-and-liquid mixture is left to stand (rest) inside the bread container 50, so that the cereal grain is soaked with the liquid. In general, the higher the liquid temperature is, the more the soaking is promoted; accordingly, the heating device 41 may be energized to raise the temperature in the baking chamber 40.

At step #14, the control device 80 checks how long it has passed since the cereal grain and liquid started to be left standing. If a predetermined length of time has elapsed, the pre-grinding soaking process #10 ends. This is indicated to the user by display on the display portion 22, by sound, or by another means.

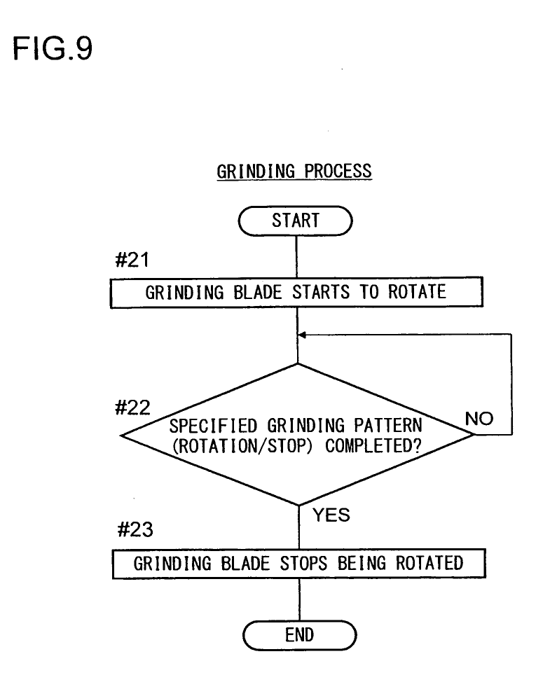

Subsequently to the pre-grinding soaking process #10, the grinding process #20 shown in FIG. 9 is performed. When the user enters grinding-related data (the kind and amount of cereal grain, the type of bread to be baked) via the operation portion 20, and presses the start key, grinding is started.

At step #21, the control device 80 drives the motor 60 to rotate both the first and second driving spindles 14L and 14R. This makes the passive spindle 53, which is coupled to the second driving spindle 14R, rotate at high speed set for the grinding blade 70. The grinding blade 70 grinds (mills) the cereal grain in the grain-and-liquid mixture. The grinding by the grinding blade 70 proceeds with the cereal grain soaked with the liquid, and thus the cereal grain can easily be ground to the core. The protrusions 50a formed on the inner surface of the bread container 50 restrict the movement of the grain-and-liquid mixture and thereby assist the grinding. The inner lid 55 closes the top-face opening of the bread container 50, and thus the cereal grain and liquid are prevented from flying out of the bread container 50.

At step #22, the control device 80 checks whether or not a grinding pattern has been completed as specified to obtain desired ground cereal grain (in terms of the following considerations: whether the grinding blade is rotated continuously, or is rotated intermittently with no-rotation periods intertwined; in the latter case, how the intervals are provided, how long the rotation periods are; etc.). If a grinding pattern as specified has been completed, an advance is made to step #23, where the grinding blade 70 stops being rotated, and the grinding process #20 ends. This is indicated to the user by display on the display portion 22, by sound, or by another means.

Although the above description deals with a case where the grinding process #20 is started in response to operation by the user after the pre-grinding soaking process #10, this is not meant as any limitation; it is also possible to adopt a configuration in which the user is allowed to enter grinding-related data before or during the pre-grinding soaking process #10 so that, after completion of the pre-grinding soaking process #10, the grinding process #20 is started automatically.

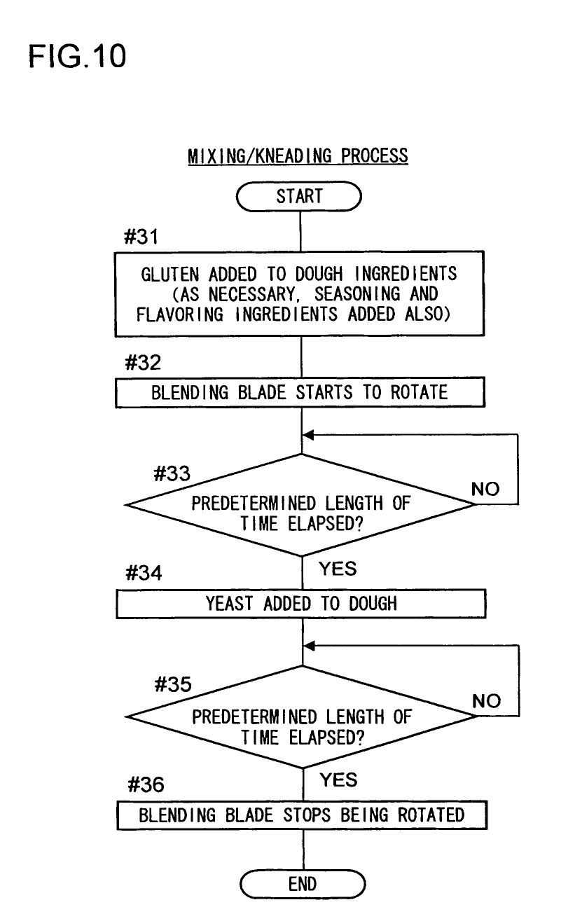

Subsequently to the grinding process #20, the mixing/kneading process #30 shown in FIG. 10 is performed. Prior to that, the user opens the lid 30, and takes the bread container 50 out of the bread container support portion 13R. The user then attaches the bread container 50 to the bread container support portion 13L so that the passive spindle 53 is coupled to the first driving spindle 14L. The user then detaches the grinding blade 70 from the passive spindle 53, and replaces it with the mixing/kneading blade 52. This interchanging needs to be performed with the ground-grain-and-liquid mixture left at the bottom of the bread container 50. Accordingly, preferably, the sleeve provided at the rotation center of each of the grinding blade 70 and the mixing/kneading blade 52 for their attachment to the passive spindle 53 is made so high that the grinding blade 70 and the mixing/kneading blade 52 can be held between fingers without the user dipping his fingers in the ground-grain-and-liquid mixture.

On completing the relocation of the bread container 50 from the bread container support portion 13R to the bread container support portion 13L and the replacement of the grinding blade 70 with the mixing/kneading blade 52, the user closes the lid 30. This brings about the state shown in FIGS. 1 and 2. The inner lid 55, no longer necessary, is stored away.

At the start of the mixing/kneading process #30, the cereal grain and liquid inside the bread container 50 are dough ingredients in the form of paste or slurry. In the present specification, the ingredients as they are at the start of the mixing/kneading process #30 are called “dough ingredients”; as the mixing/kneading proceeds, they gradually approach the state of a desired dough, and the ingredients in these stages will be called “dough” even if still in an unfinished state.

At step #31, the user opens the lid 30, and adds a predetermined amount of gluten to the dough ingredients. As necessary, the user also adds seasoning and flavoring ingredients such as salt, sugar, shortening, etc.

Before or after step #31, the user enters via the operation portion 20 a bread type and a recipe. When ready, the user presses the start key, and this starts bread making operation that automatically proceed through the mixing/kneading process #30, the leavening process #40, and the baking process #50.

At step #32, the control device 80 drives the motor 60. This makes the mixing/kneading blade 52 start to rotate in the dough ingredients. As mentioned previously, the first driving spindle 14L receives the rotation of the motor 60 after speed reduction, and the mixing/kneading blade 52 thus rotates at low speed and high torque.

While driving the motor 60, the control device 80 energizes the heating device 41 to raise the temperature in the baking chamber 40. As the mixing/kneading blade 52 rotates, the dough ingredients are mixed and kneaded into smooth dough with predetermined resilience (pliability). The mixing/kneading blade 52 swings the dough around and beats it against the inner wall of the bread container 50, and thus the mixing/kneading here involve “kneading”. The protrusions 50a formed on the inner wall of the bread container 50 assist the “kneading.”

At step #33, the control device 80 checks how long it has passed since the mixing/kneading blade 52 started to be rotated. If a predetermined length of time has elapsed, an advance is made to step #34. At step #34, the user opens the lid 30, and add yeast to the dough.

At step #35, the control device 80 checks how long it has passed since the yeast was added to the dough. If a length of time necessary to obtain desired dough has elapsed, then an advance is made to step #36, where the mixing/kneading blade 52 stops being rotated. Now, smooth dough with predetermined resilience has been finished.

The yeast added to the dough at step #34 may be a dry yeast. Instead of yeast, baking powder may be used.

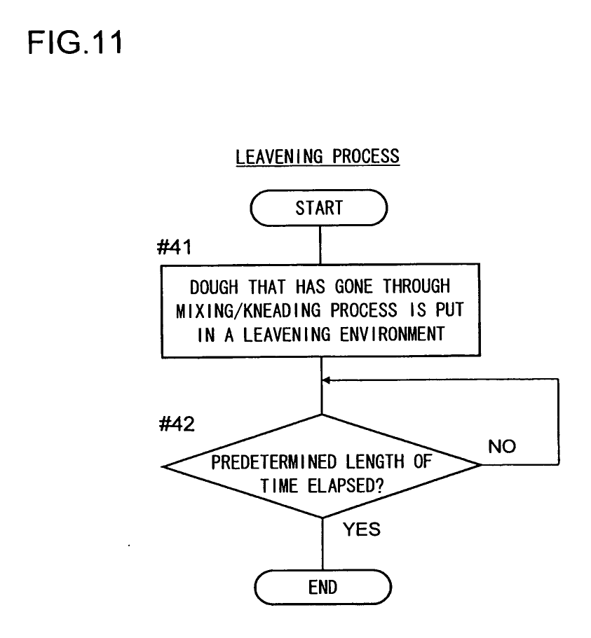

Subsequently to the mixing/kneading process #30, the leavening process #40 shown in FIG. 11 is performed. At step #41, the dough that has gone through the mixing/kneading process #30 is put in a leavening (fermenting) environment. Specifically, as necessary, the control device 80 energizes the heating device 41 to keep the baking chamber 40 in a temperature zone in which leavening proceeds. The user shapes the dough as necessary and leaves it to stand.

At step #42, the control device 80 checks how long it has passed since the dough was put in the leavening environment. If a predetermined length of time has elapsed, the leavening process #40 ends.

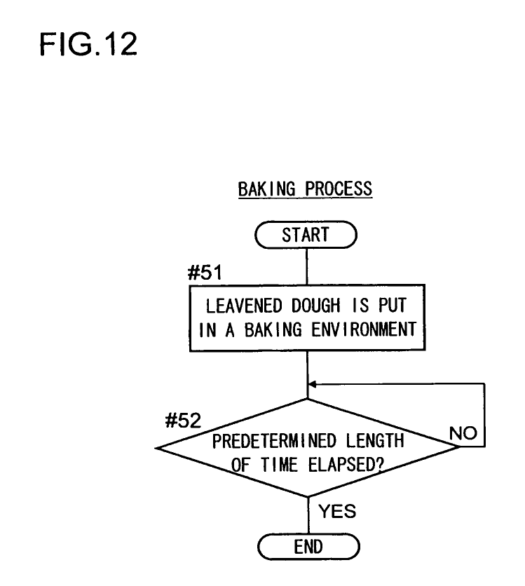

Subsequently to the leavening process #40, the baking process #50 shown in FIG. 12 is performed. At step #51, the leavened dough is put in a baking environment. Specifically, the control device 80 supplies the heating device 41 with electric power necessary to bake bread to raise the temperature in the baking chamber 40 into a temperature zone for bread baking.

At step #52, the control device 80 checks how long it has passed since the dough was put in the baking environment. If a predetermined length of time has elapsed, the baking process #50 ends. Here, the completion of bread baking is indicted by display on the display portion 22 or by sound; the user then opens the lid 30 and takes the bread container 50 out.

During the baking process #50, the user can see the inside of the bread container 50 to check how the bread has risen and browned.

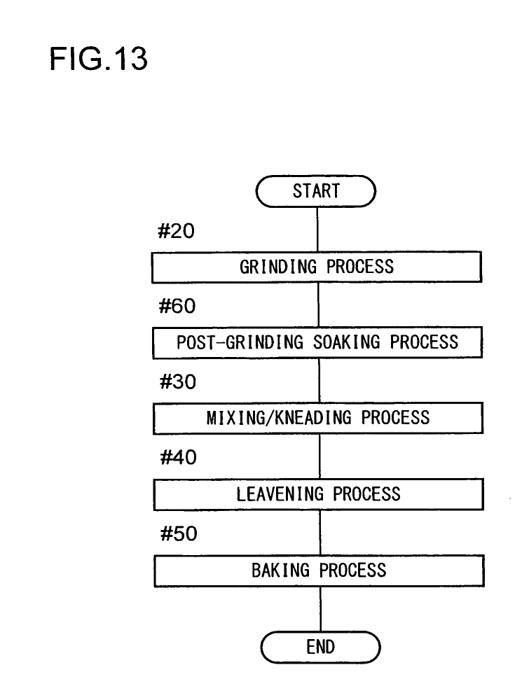

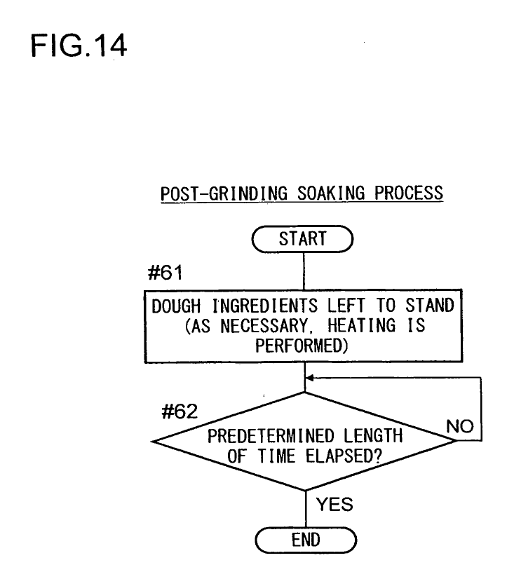

Next, a description will be given of a procedure for making bread according to a second example (Example 2) of the invention, with reference to FIGS. 13 and 14. FIG. 13 is an overall flow chart of the bread making procedure of Example 2. In FIG. 13, different processes are gone through in the following order: a grinding (milling) process #20, a post-grinding soaking process #60, a kneading process #30, a leavening (fermenting) process #40, and a baking process #50. Now, with reference to FIG. 14, what takes place in the post-grinding soaking process #60 will be described.

At step #61, the dough ingredients formed in the grinding process #20 are left to stand (rest) inside the bread container 50. The dough ingredients here have not gone through a pre-grinding soaking process. While the dough is left standing, the ground cereal grain is soaked with the liquid. As necessary, the control device 80 energizes the heating device 41 to heat the dough ingredients and thereby promote the soaking. Here, the bread container 50 may be attached to the bread container support portion 13R, or may be attached to the bread container support portion 13L.

At step #62, the control device 80 checks how long it has passed since the dough ingredients started to be left standing. If a predetermined length of time has elapsed, the post-grinding soaking process #60 ends. On completion of the post-grinding soaking process #60, an advance is made to the mixing/kneading process #30. If the post-grinding soaking process #60 was performed with the bread container 50 supported on the bread container support portion 13L and with the mixing/kneading blade 52 attached to the passive spindle 53, an advance can automatically be made to the kneading process. The processes after the mixing/kneading process #30 are the same as in the bread making procedure of Example 1.

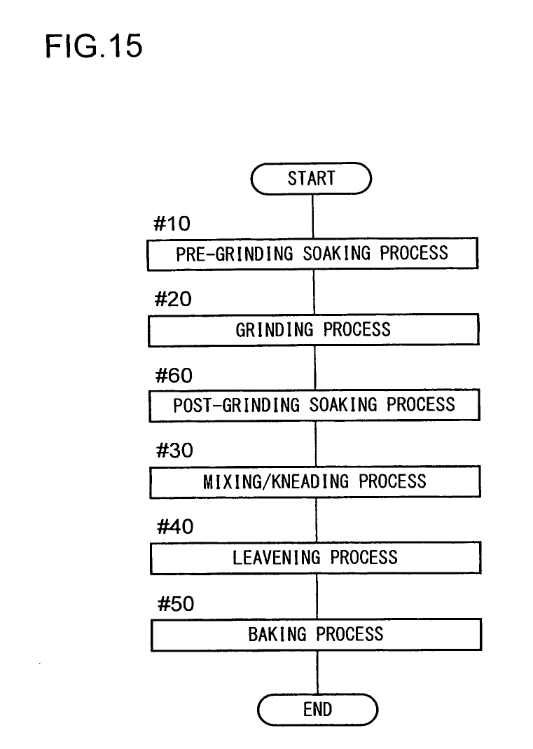

Next, a description will be given of a procedure for making bread according to a third example (Example 3) of the invention, with reference to FIG. 15. FIG. 15 is an overall flow chart of the bread making procedure of Example 3. Here, a pre-grinding soaking process #10 like that in Example 1 comes before a grinding (milling) process #20, and the grinding process #20 is followed by a post-grinding soaking process #60 like that in Example 2. The processes after the mixing/kneading process #30 are the same as in the bread making procedure of Example 1.

The grinding blade 70 can be used not only for the grinding or milling of cereal grain but also for the mincing or crushing of ingredients such as nuts and leafy vegetables. This makes it possible to bake bread containing additional ingredients in the form of fine grain. The grinding blade 70 can also be used for the mincing or crushing of foods other than additional ingredients to be mixed with bread and of materials for herbal medicines.

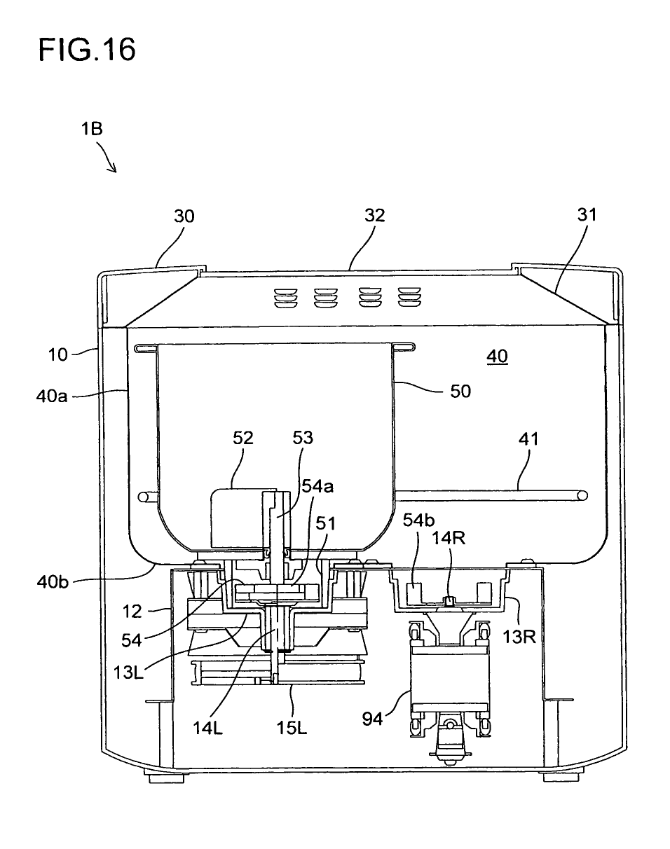

Next, with reference to FIGS. 16 to 19, a second embodiment (Embodiment 2) of the invention will be described. It should be noted that those components in Embodiment 2 which have the same or equivalent functions as their counterparts in Embodiment 1 will be identified by the same reference signs as used for Embodiment 1 and their description will not be repeated.

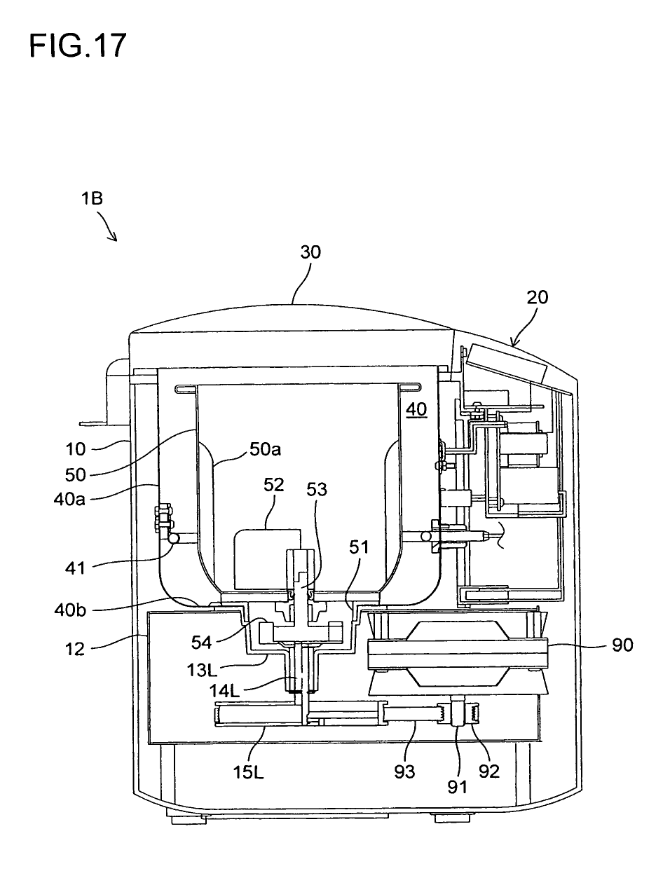

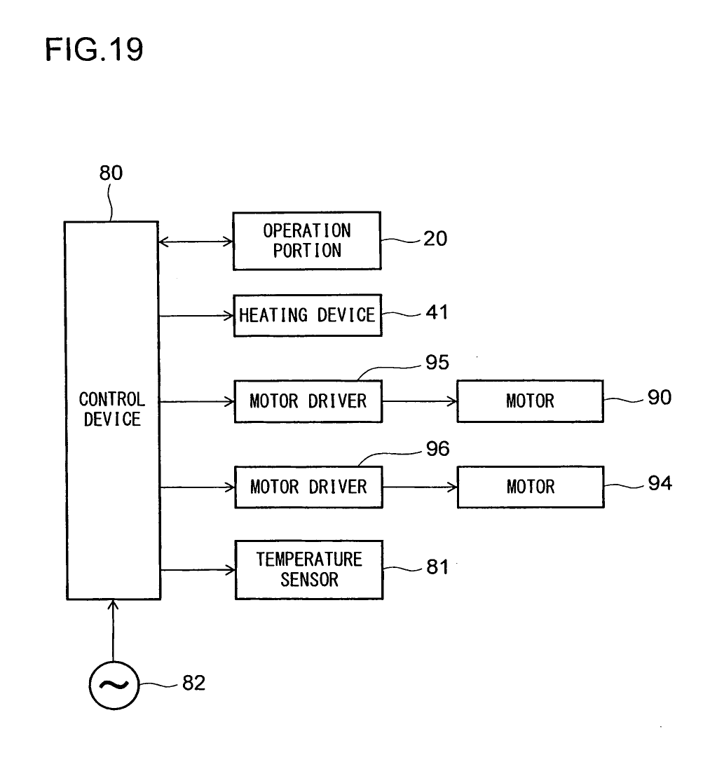

The automatic bread making machine 1B of Embodiment 2 differs from the automatic bread making machine 1A of Embodiment 1 in that the first and second driving spindles 14L and 14R are driven by separate motors. Specifically, the base 12 is fitted with a motor 90 (see FIG. 17) of a vertical spindle type; to the output spindle 91 of the motor 90 is fixed a pulley 92, and the pulley 92 is coupled via a belt 93 to the pulley 15L of the first driving spindle 14L. On the bread container support portion 13R side, a motor 94 is directly coupled to the second driving spindle 14R. As shown in FIG. 19, the motor 90 is combined with a motor driver 95, and the motor 94 is combined with a motor driver 96.

In FIGS. 16 and 17, the bread container 50 is attached to the bread container support portion 13L, and the passive spindle 53 is coupled to the first driving spindle 14L. Here, a motor of a low-speed, high-torque type is selected as the motor 90 for supplying the first driving spindle 14L with rotation for the mixing/kneading blade 52 (i.e., for rotating the first driving spindle 14L and hence the mixing/kneading blade 52).

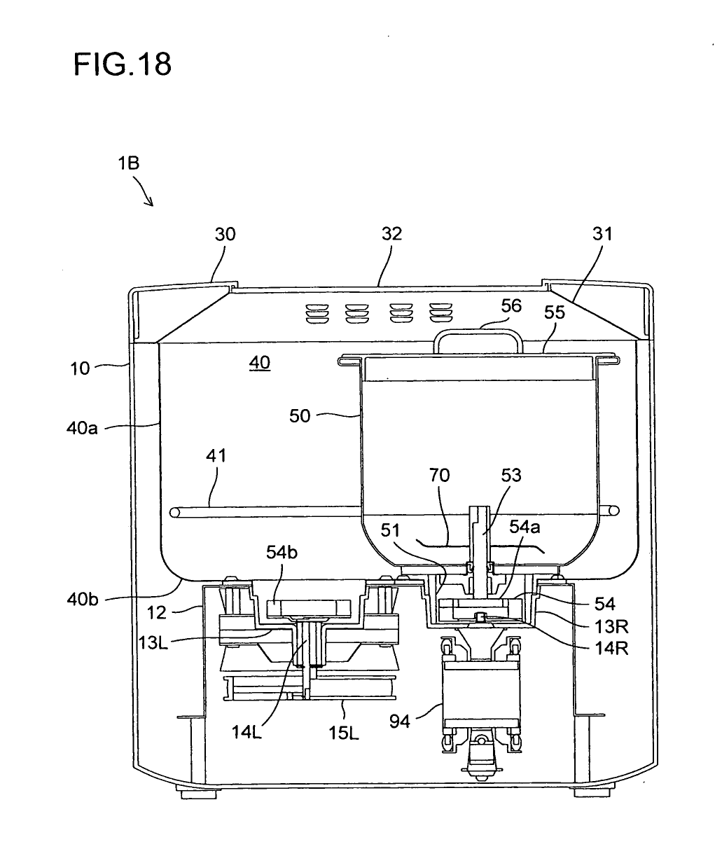

In FIG. 18, the bread container 50 is attached to the bread container support portion 13R, and the passive spindle 53 is coupled to the second driving spindle 14R. Here, a motor of a high-speed type is selected as the motor 94 for supplying the second driving spindle 14R with rotation for the grinding blade 70 (i.e., for rotating the second driving spindle 14R and hence the grinding blade 70).

With the construction described above, the mixing/kneading blade 52 and the grinding blade 70 can be driven without regard to each other's operation. Also, it is easy to give each of the mixing/kneading blade 52 and the grinding blade 70 an optimal rotation rate (i.e., they can each be rotated at an optimal rate of revolution). Moreover, unlike the automatic bread making machine 1A of Embodiment 1, it does not occur that, while the passive spindle 53 is rotating together with the first driving spindle 14L, the second driving spindle 14R rotates together, or that while the passive spindle 53 is rotating together with the second driving spindle 14R, the first driving spindle 14L rotates together.

In both Embodiments 1 and 2, a single control device 80 can control the rotation of the grinding blade 70 and the rotation of the mixing/kneading blade 52 in association with each other. In this way, at each of the stage of grinding cereal grain and the stage of mixing/kneading the cereal grain after the grinding, it is possible to feed the grinding blade 70 and the mixing/kneading blade 52 with rotation (i.e., rotate them in ways) suitable for the kind and amount of cereal grain, and thereby to enhance the quality of the bread.

While the present invention has been described by way of embodiments, these embodiments are in no way meant to limit the scope of the invention; the invention may be carried out with many variations and modifications made without departing from its spirit.

What is claimed is:

1. An automatic bread making machine that sequentially performs a mixing/kneading process, a leavening process, and a baking process, the automatic bread making machine comprising:
a bread container for containing a bread making ingredient, the bread container having a passive spindle that permits selective attachment of a mixing/kneading blade or a grinding blade in a bottom part of the bread container;
a baking chamber provided inside a cabinet of the automatic bread making machine, for housing the bread container;
a first driving spindle disposed in a bottom part of the baking chamber, the first driving spindle being so disposed that the first driving spindle can be coupled to the passive spindle to feed the passive spindle with rotation for the mixing/kneading blade; and
a second driving spindle disposed in the bottom part of the baking chamber in a position deviated from the first driving spindle, the second driving spindle being so disposed that the second driving spindle can be coupled to the passive spindle to feed the passive spindle with rotation for the grinding blade.

2. The automatic bread making machine according to claim 1,
wherein the first and second driving spindles are driven by a common motor.

3. The automatic bread making machine according to claim 1,
wherein the first and second driving spindles are driven by separate motors.

4. The automatic bread making machine according to claim 3,
wherein the motor for rotating the first driving spindle and the motor for rotating the second driving spindle are controlled by a common control device.
